(19) United States
(12) Patent Application Publication
(10) Pub. No.: US 2015/0270020 A1
(43) Pub. Date: Sep. 24, 2015

(54) Device for creating nuclear fusion

(71) Applicant: William R. Estlick, SR., Mashpee, MA (US)

(72) Inventor: William R. Estlick, SR., Mashpee, MA (US)

(21) Appl. No.: 13/999,699

(22) Filed: Mar. 18, 2014

(51) Int. Cl. G21B 1/05; H01J 27/14; H01J 61/06

(52) U.S. Cl. CPC G21B 1/057; H01J 61/06; H01J 27/146

(57) ABSTRACT

One embodiment of a thermonuclear fusion reactor consists of 2 opposing cathodes and 1 anode positioned outside the gap created by the cathodes. This device creates the environment for thermonuclear fusion to occur for the purpose of creating usable energy.

Other embodiments are described.

### CROSS-REFERENCE TO RELATED APPLICATIONS

None

### FEDERALLY SPONSORED RESEARCH

Not applicable

### SEQUENCE LISTING OR PROGRAM

Not applicable

### BACKGROUND

1. Field of Invention

This invention relates to thermonuclear fusion; the process of producing energy by fusing lighter elements into heaver elements.

2. Prior Art

Thermonuclear fusion produces energy by fusing lighter elements into heaver elements. The mass of the new element is lighter than the two original nuclei; the difference in mass is converted to energy. At this time a viable thermonuclear fusion reactor has not been built because of the technical difficulties and inefficiencies of the current designs being pursued.

There are currently three main types of fusion reactors being explored.
1. Tokamaks
2. Laser or Nova System
3. Farnsworth Fusers

Here I will describe these devices.

### Tokamaks:

Tokamaks attempt to produce energy by confining and heating fuel in the form of plasma in a toroidal or doughnut shaped magnetic field. This “magnetic bottle” has the advantage of keeping the plasma from coming into contact with the walls of the chamber. The problem with tokamaks is that inevitably, as the plasma is compressed, it leaks out of its confinement field. The plasma then comes into contact with the walls of the chamber thereby cooling and contaminating the plasma. Secondly, an incredible amount of energy is used just to create the magnetic field, that energy is not used to heat the plasma.

### Internal Confinement Fusion “ICF”:

This concept fires lasers at a pellet of fuel from multiple directions, heating and compressing the fuel creating the conditions for fusion to occur. The problem with this method is that lasers are inherently inefficient. Also the conditions for fusion are momentary, not sustainable and have to be recreated for each “shot”. At this time only 1/100^{th} the energy put into the reactor is released as energy produced by the reaction.

### Farnsworth Fuser:

Farnsworth Fuser works by holding and compressing plasma “fuel” inside an electrostatic field. It has been determined that it will never be a viable source of energy as the plasma will always leak out of the confinement field before the plasma reaches high enough densities and temperatures to be useful.

All three devices use considerable energy just to create and maintain the environment for fusion to occur (with the exception of the Farnsworth Fuser). These “machines” are extremely expensive and difficult to build (with the exception of the Farnsworth Fuser) and are highly inefficient.

### SUMMARY

One embodiment for creating thermonuclear fusion that consists of a chamber in which to contain the fuel. Electrodes consisting of 2 opposing cathodes in the center of the chamber and one anode positioned outside the gap created by the cathodes. The gaps between electrodes may be stationary or adjustable.

Positively charged ions are accelerated toward the negatively charged electric field created by the cathodes. Ions are deterred from colliding with the cathodes by the influence of the opposing cathodes electric field. Ions missing the cathodes enter an orbit between and around the electrodes.

Plasma densities increase over time as more and more ions enter an orbit around the cathodes. Collisions between ions raise the temperature of the plasma and the ions orbits become larger decreasing the probability of colliding with the cathodes.

When collisions between ions occur at high enough energy, ions fuse and release energy.

### DRAWINGS—FIGURES

FIG. 1 Shows the configuration of electrodes that create the electric field. A cross section of the two cathodes (b) and the gap between them (f) for ions to pass through and around. The anode (a) outside the gap created by the cathodes.

FIG. 2 Shows the electrode (c) at the tip or face of the cathode.

FIG. 3 Shows the hypothetical path (g) of an ion accelerating from anode to cathode without the influence of an opposing cathode. (h) Shows the path of an ion from anode to the electric field generated by opposing cathodes causing it to miss and enter an orbit.

### DRAWING REFERENCES

a. Anode—a positively charged electrode.
b. Cathode—a negatively charged electrode.
c. Electrode—a charged conductor
d. Conductor—a path for current to flow
e. Insulation—a dielectric material.
f. Gap—the space between cathodes that create an area of negatively charged field.
g. Hypothetical trajectory of an ion from anode to cathode without the influence an opposing cathode.
h. Hypothetical trajectory of an ion from anode to cathode influenced by opposing cathode.
i. Ion—a positively charged particle

### DETAILED DESCRIPTION

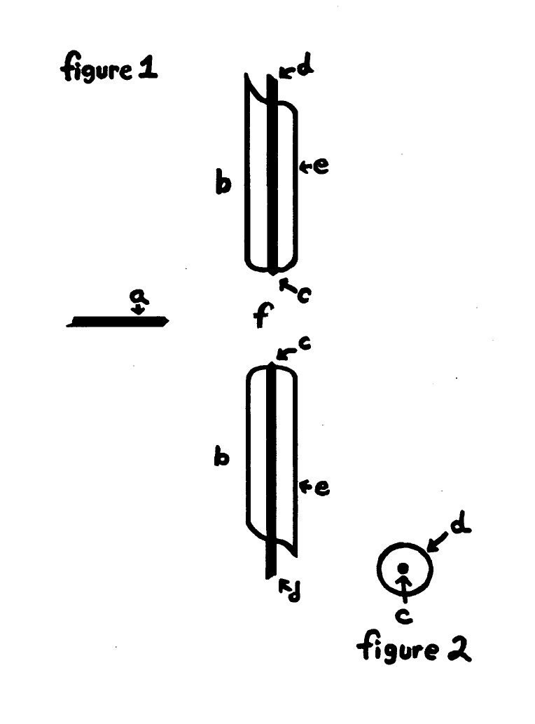

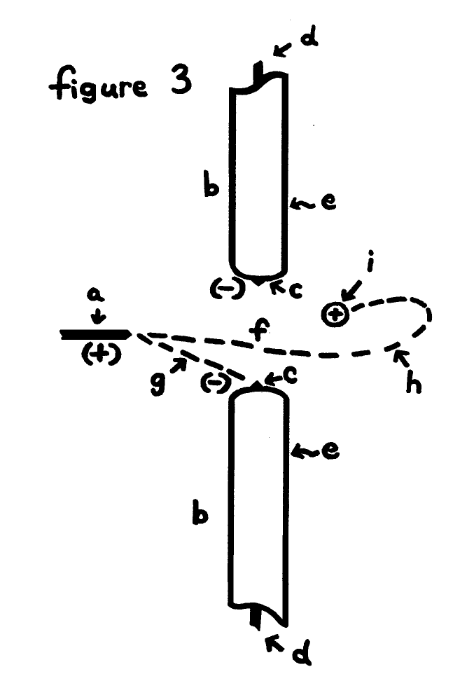

### FIGS. 1-3—Preferred Embodiment

One embodiment of a nuclear fusion reactor is illustrated in FIG. 1.

A chamber that controls the fuel, usually deuterium and tritium. Inside the chamber are 2 opposing cathodes that creating a gap and 1 anode positioned outside the gap created by the cathodes. The space between the electrodes may be stationary or adjustable. The cathodes may be electrically bonded or electrically isolated from one another.

The cathodes in this embodiment are placed in the middle of the chamber opposing each other; insulation restricts the flow of current to the tip of the cathodes. An anode is placed outside the gap created by the 2 cathodes. The walls of the enclosing chamber may be used as the anode, positively charged in addition to the anode to assist in the confinement of plasma.

### Operation of Invention

Fuel is injected into the chamber. This fuel may consist of hydrogen, deuterium and or tritium and may enter the chamber as ions. High voltages applied to the electrodes create a negative electric field between the cathodes. Ions accelerate toward the negative electric field and pass between and around the cathodes accumulating into a plasma cloud.

As ions heat through friction and or other external means, there orbits become larger reducing the probability of colliding with the cathodes. Voltages and or current may be varied or oscillated to assist heating the plasma and the gap of the electrodes may be adjusted. During experiments, dense plasma clouds have been observed as well as coherent stable plasma structures (plasmids).

At high enough energies; ions collide, fuse and release usable energy.

### Description and Operation of Alternative Embodiments

More than 1 anode and more than 2 cathodes may be used in various configurations to produce different electric fields and plasma structures. But the concept always remains the same, a gap is created between two or more cathodes and one or more anode positioned outside that gap causing ions to orbit between and around cathodes. Voltages and or current may be varied and or oscillated to assist in heating the plasma creating the environment for nuclear fusion to occur.
This device also generates different types of electromagnetic radiation depending on the type of gasses in the chamber and the type of current applied.

### Advantages

There are several advantages to this type of device.
1. The power used in this device directly holds and heats the plasma making it more efficient.
2. There is no theoretical limit as to how much current that can be used in the device.
3. It is comparatively simple to construct compared to other devices.
4. It is comparatively inexpensive to construct compared to other devices.

### Conclusion, Ramifications and Scope of Invention

The production of energy from hydrogen fusion has the potential to benefit humanity. It produces little or no pollution. The fuel is easily obtained and essentially limitless. It can break our dependency of fossil based fuels and the countries that control their production. It has the potential to slow man made climate change and benefit economic development.

I claim:

1. A device consisting of two or more opposing cathodes and one or more anodes positioned outside the gap created by the cathodes for the purpose of creating thermonuclear fusion.
a. Like electrodes of this device may be electrically bonded or isolated.
b. Voltage and or current may be varied and or oscillated to assist in heating and or holding plasma.
c. The gap between electrodes may be stationary or adjustable.

2. A device consisting of two or more opposing cathodes and one or more anodes outside the gap created by the cathodes for the purpose of creating electromagnetic radiation.
a. Like electrodes of this device may be electrically bonded or isolated.
b. Voltage and or current may be varied and or oscillated to assist in heating and or holding plasma.
c. The gap between electrodes may be stationary or adjustable.
